(19) United States
(12) Patent Application Publication
(10) Pub. No.: US 2015/0276311 A1
(43) Pub. Date: Oct. 1, 2015

(54) FINISH CURING METHOD AND SYSTEM FOR LEATHER-BASED SUBSTRATES

(71) Applicants: Karl ROHR, Windsor (CA); Nathan MULLINIX, Rochester, MI (US); Donald VESEY, Oakland, MI (US); Robert Curtis LEACH, Allenhurst, NJ (US)

(72) Inventors: Karl Rohr, Windsor (CA); Nathan Mullinix, Rochester, MI (US); Donald Vesey, Oakland, MI (US); Robert Curtis Leach, Allenhurst, NJ (US)

(21) Appl. No.: 14/428,851

(22) PCT Filed: Sep. 19, 2013
(86) PCT No.: PCT/US13/60639

§ 371 Date: Mar. 17, 2015

Related U.S. Application Data
(60) Provisional application No. 61/704,239, filed on Sep. 21, 2012.

(51) Int. Cl. F26B 3/30; C14C 15/00; H05B 3/00; C14C 11/00

(52) U.S. Cl. CPC F26B 3/30; C14C 11/00; C14C 15/00; H05B 3/0038

(57) ABSTRACT

A method and system for finish curing a leather-based substrate includes applying a base coat onto a surface of a substrate to form a coated substrate and passing the coated substrate through a first heating zone to heat the base coat. The method also includes passing the coated substrate through a second heating zone that emits infrared electromagnetic waves at a frequency corresponding to strong absorption by water to remove a desired amount of moisture from the base coat, and passing the coated substrate through a third heating zone to completely cure the base coat on the coated substrate.

### CROSS REFERENCES TO RELATED APPLICATIONS

This application claims the benefit of the filing date of U.S. Provisional Patent Application No. 61/704,239 entitled “Finish Curing Method and System for Leather-Based Substrates” filed Sep. 21, 2012, which is hereby incorporated by reference for all purposes as if set forth in its entirety herein.

### STATEMENT REGARDING FEDERALLY SPONSORED RESEARCH

Not Applicable.

### BACKGROUND OF INVENTION

Common finishing practices for applying prime, base and top or finish paint coats to leather and non-leather substrates implement one or more of air spray and roll coat transfer systems. Curing processes that are used to dry the paint coats utilize industry-standard steam, hot oil, gas-fired or electric element convection ovens. Although these conventional ovens and curing processes meet their functional objectives, they possess several aspects of inefficiency. For example, these ovens have limited capabilities to adjust thermal conditions of a substrate being cured and include long response times (for example, up to 20 minutes) to obtain thermal energy changes without adversely affecting the substrate or coating. Also, current convection oven technology typically requires higher levels of energy to reach and maintain target temperatures to adequately dry coatings applied to a substrate surface. These downfalls result in potential over or under curing of the substrate resulting in mud cracking or tackiness, as well as excessive energy use for heat up conditions and extensive down time for cleaning of the oven heat sources to maintain radiant efficiencies. Furthermore, curing processes that use conventional ovens require additional equipment and floor space for inclusion of a final “air off” oven section to assure proper cure.

Therefore, a need exists for a system and method for finish curing leather-based substrates that overcome the above-identified inefficiencies of current industry standards.

### SUMMARY OF THE INVENTION

According to one aspect, the present invention provides a method of finish curing a leather-based substrate. A base coat is applied onto a surface of a substrate to form a coated substrate and the coated substrate is passed through a first heating zone to heat the base coat. The coated substrate is passed through a second heating zone that emits infrared electromagnetic waves at a frequency corresponding to strong absorption by water to remove a desired amount of moisture from the base coat. The coated substrate is then passed through a third heating zone to completely cure the base coat on the coated substrate.

In some forms of this method, the frequency corresponding to strong absorption by water may be in a range of 2900-3100 nanometers.

In some forms of this method, a temperature of the coated substrate passing through the second heating zone may be sensed and a power level of the second heating zone may be adjusted to maintain a desired temperature of the coated substrate.

In some forms of this method, air may be directed over the coated substrate that is passing through the second heating zone to remove moisture building up on the coated substrate.

In some forms of this method, the coated substrate may be passed through a cooling unit to cool the base coat after the base coat has been completely cured.

In some forms of this method, a color coat may be applied onto the surface of the coated substrate after the coated substrate has been cooled by the cooling unit.

According to another aspect, the present invention also provides a system for finish curing a coated substrate. The system includes a conveyor that passes the coated substrate through a first heating zone, a second heating zone, and a third heating zone. The first heating zone includes a first infrared emitter module that heats the coated substrate. The second heating zone includes a second infrared emitter module that emits infrared electromagnetic waves at a frequency corresponding to strong absorption by water to remove a desired amount of moisture from the coated substrate. The third heating zone includes a third infrared emitter module to completely cure the coated substrate.

In some forms of this system, the frequency corresponding to strong absorption by water may be in a range of 2900-3100 nanometers.

In some forms of this system, the system may further include a controller providing power to the second infrared emitter module to heat the second emitter module to about 1300 degrees Fahrenheit. The controller may sense a temperature of the coated substrate passing through the second heating zone and further may adjust a power level of the second infrared emitter module to maintain a desired temperature of the coated substrate.

In some forms of the system, the system may further include an air manifold. The air manifold may direct air over the coated substrate as the substrate passes through the second heating zone to remove moisture building up on the coated substrate. The directed air may be warmed by the second infrared emitter module.

In some forms of the system, one or more of the second infrared emitter module and the third infrared emitter module may include ceramic fiber mounted panels with perforated ventilation holes.

In some forms of the system, the system may further include a cooling unit. After the coated substrate has been passed through the third heating zone, the conveyor may pass the coated substrate through the cooling unit.

According to another aspect, a method according to the present invention can include applying a base coat onto a surface of a substrate to form a coated substrate and passing the coated substrate through a first curing stage to heat, dry, and completely cure the base coat on the coated substrate. The first curing stage includes at least one heating zone emitting infrared electromagnetic waves at a frequency corresponding to strong absorption by water to remove a desired amount of moisture from the base coat. The method also includes applying a color coat onto a surface of the coated substrate to form a colored substrate and passing the colored substrate through a second curing stage to heat, dry, and completely cure the color coat on the colored substrate. The second curing stage includes at least one heating zone emitting infrared electromagnetic waves at the frequency corresponding to strong absorption by water to remove a desired amount of moisture from the color coat.

The foregoing and other objects and advantages of the invention will appear from the following detailed description. In the description, reference is made to the accompanying drawings which illustrate a preferred embodiment of the invention.

### BRIEF DESCRIPTION OF THE DRAWINGS

FIG. 1 is a flow chart of a leather coating and finishing process according to one embodiment of the invention.

FIG. 2 is side view of a system for carrying out the leather coating and finishing process of FIG. 1.

FIG. 3 is an underside view of an infrared emitter module for use with the system of FIG. 2.

### DETAILED DESCRIPTION OF THE INVENTION

The present invention provides a high efficiency finish curing system and method for coatings applied to leather and non-leather alternative substrates. The finish curing process attains optimal finished product improvements through the utilization of multiple infrared (IR) emitter oven components in place of one or more conventional gas and electric-resistance element thermal units. These equipment changes, as well as other process enhancements further described below, result in a much more responsive curing process in comparison to current industry standards, which minimizes the amount of residence time within ovens and air off or cooling of the substrates.

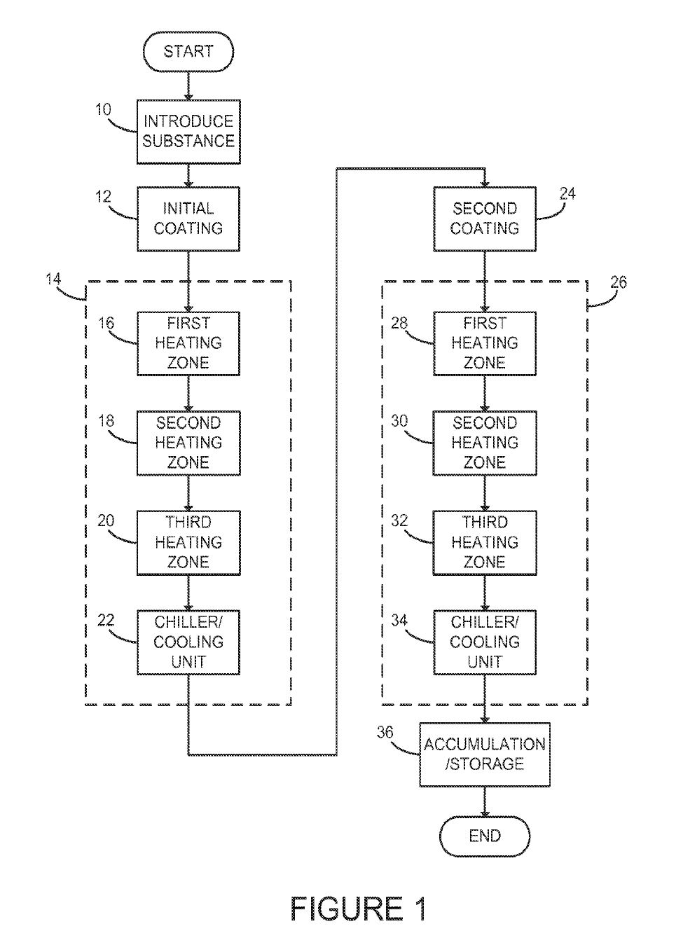

FIG. 1 illustrates a leather coating and finishing process according to one embodiment of the invention. At step 10, a substrate (for example, leather or non-leather alternative) is introduced on a conveyor line. With respect to rolled substrates, a preliminary unwinding step (not shown) is required where the substrates are fed through a 90-degree roller turn and de-dusted before being introduced onto the conveyor line. At step 12, the substrate proceeds to an initial coating station where a prime or base coat is applied by air spray or a roller coat apparatus. Following step 12, the coated substrate proceeds to a first curing stage 14, where the applied coatings are dried and chemically cured as a cross-linked thermoset. Within the first curing stage 14, at step 16, the coated substrate proceeds to a first heating zone including an infrared (IR) high purity emitter module to heat the substrate. At step 18, the coated substrate proceeds to a second heating zone where all required moisture is removed from the coating. The second heating zone includes a similar IR emitter module, or modules, with integrated perforated ceramic fiber mounted panels. Perforated ventilation holes through the ceramic panels create disruptive air flow across substrate surfaces in order to increase evaporation and encourage removal of a water-laden vapor barrier from the substrate surface as the substrate is drying. After exiting the second heating zone, the substrate proceeds to a third heating zone at step 20. The third heating zone, including another IR emitter module, continues to maintain the coating temperature to assure complete cure, or crosslinking of the coating. At step 22, the substrate continues through a chiller/cooling unit to cool the coated substrate, and at step 24, the substrate proceeds to a second coating station where a color coat is applied.

Following step 24, the colored substrate proceeds to a second curing stage 26, including a first heating zone (step 28), a second heating zone (step 30), a third heating zone (step 32), and a cooling unit (step 34). The first curing stage 14 and the second curing stage 26 include substantially identical equipment (i.e., all heating zones include IR emitter modules). Following the second curing stage 26, the substrate proceeds to an accumulation/storage stage (step 36) for subsequent steps such as embossing and/or additional finishing.

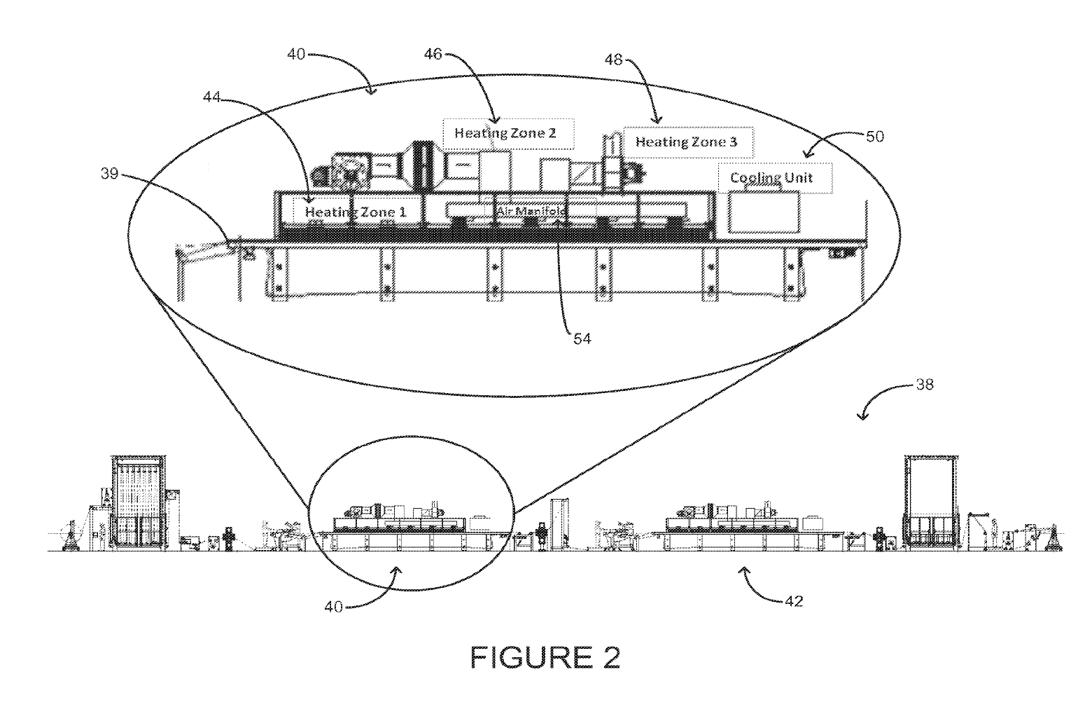

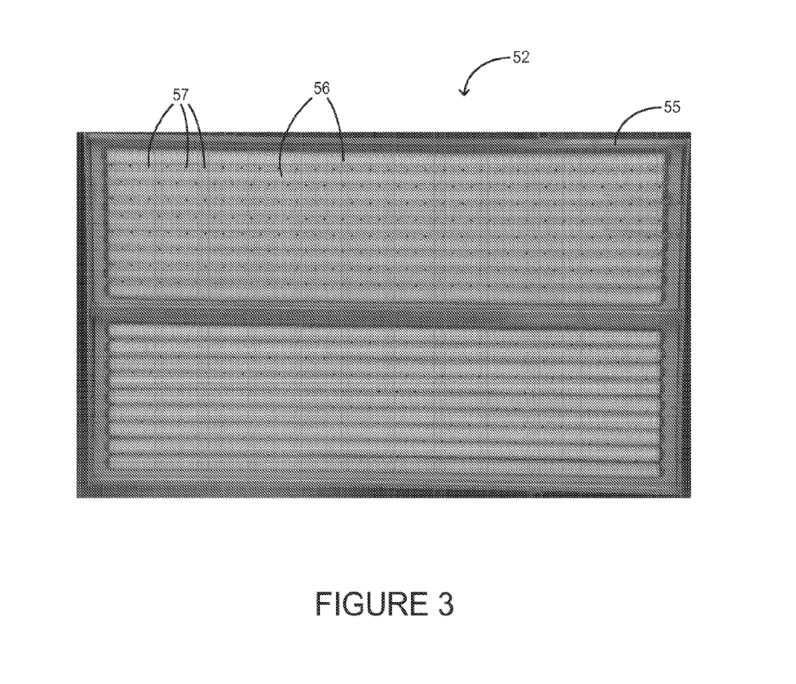

FIG. 2 illustrates a system 38 for carrying out the process described above. More specifically, FIG. 2 illustrates a system 38 with one or more conveyor lines 39 for passing a substrate through a first curing stage 40 and a second curing stage 42. The curing stages 40, 42 are substantially identical and each includes a first heating zone 44, a second heating zone 46, a third heating zone 48, and a chiller/cooling unit 50. Each of the heating zones 44, 46, and 48 include IR emitter modules 52 (shown in FIG. 3). The IR emitter modules 52 emit specific peak IR frequencies that are matched to water or, in other words, include the peak absorption range of water (for example, approximately 2900 nanometers to approximately 3100 nanometers) so that, when the IR energy is emitted toward a substrate surface, water molecules throughout the coating and substrate layers absorb the electromagnetic IR. IR absorption causes the water molecules to vibrate, resulting in friction and elevation of the water temperature in order to convert the liquid water molecules into gaseous water vapor. This allows a more effective removal of the water in the vapor state with only a slight air turbulence directed toward the substrate surface when combined with adequate exhaust air flow.

The IR absorption and evaporation of water molecules described above also eliminates solidification of the coating on the substrate surface, thus promoting consistent curing which results in an even coating thickness. The consistent and even coating thickness allows evaporated water molecules to escape the coating surface, preventing the creation of surface defects such as pin holes and blistering, among other issues, due to entrapment of gases (that is., water vapor) under the substrate surface. The IR energy transmitted to the surface also elevates the solids temperature within the coating after the moisture is removed to achieve a complete, thermoset, cross-linked cure of the remaining solids in the coating system (for example, while in the third heating zone 48 described above).

In addition to IR emission, forced ambient air is applied in one or more of the heating zones 44, 46, and 48 to help accomplish consistent and even curing of the substrate coating. For example, FIG. 2 illustrates an air manifold 54 in both the second heating zone 46 and the third heating zone 48 to provide the forced air. The forced air within the heating zones 44, 46, and 48 is directed over the coated substrate in order to permit the surface temperature of the coated substrate to be maintained while a portion of specific IR-wavelength emissions are transmitted through the coating surface, as described above. Also, the IR emitter modules 52 each include perforated ceramic fiber mounted panels 55, as shown in FIG. 3. The forced air is forced through perforated ventilation holes 57 of the ceramic panels 55 to reach the substrate surfaces. Providing the perforated ventilation holes 57 through the ceramic panels 55 creates disruptive air flow across the substrate surfaces in order to increase water evaporation and encourage removal of the water-laden vapor barrier from the substrate surface as the substrate is drying. The forced air is also heated as it passes through the IR emitter modules 52 to reach the substrate surfaces. The warmed forced air, with or without the ventilation holes 57 causing disruptive air flow, allows efficient curing without an oven “air off” step, as is required with conventional curing. Elimination of the “air off” step substantially reduces required equipment investment and floor space, resulting in a more efficient facility layout.

The IR emitter modules 52 described above each include a primary IR emitter source with stamped elements 56, as shown in FIG. 3, constructed from a thin band of an alloy (i.e., Kanthal®) which has been formulated to contain copper, iron and aluminum. This alloy, when heated to about 1700 degrees Fahrenheit (about 925 degrees Celsius), causes the aluminum to migrate to the surface of the element in the form of alumina. Alumina, a non-oxidizing and non-conductive “ceramic-like” material, provides each emitter element 56 with extended life expectancy up to 10 times that of conventional nickel chromium resistive heating elements which experience continuous oxidization at a steady rate while heated until the material has been spent and element failure occurs.

In addition, the use of Kanthal® heating elements 56 coupled to the ceramic fiber mounted panels 55 enables self cleaning capabilities of the IR emitter modules 52 and removes the need for reflectors. These are both unique benefits over standard industry convection ovens, and the self-cleaning capabilities also provide for reduced downtime in comparison to industry standard convection ovens.

The elements 56 of the IR emitter modules 52 each consist of a very low mass, allowing a higher responsiveness to applied current and, as a result, an approximate three to four-second heat up from standby temperatures of about 500 degrees Fahrenheit (260 degrees Celsius) to about 1300 degrees Fahrenheit (705 degrees Celsius) [about 1280 degrees Fahrenheit (693 degrees Celsius) achieves 3000 nanometer IR transmissions, which are absorbed by water molecules at almost 100% efficiency], and an approximate five-second cool down to below about 500 degrees Fahrenheit (260 degrees Celsius). Furthermore, quick changes in heating zone temperatures can be accomplished by adjusting power applied to the emitter modules 52.

The fast heat up and cool down aspects of the IR emitter elements 56 permit a relatively close distance between the elements 56 and a substrate along a conveyor line 39 in the heating zones 44, 46, and 48 and eliminates the need to utilize mechanical retraction to remove the IR emitter elements 56 away from the moving material substrate on the conveyor line 39. The ability to keep the IR emitter elements 56 close to the substrate produces high system efficiencies as compared to conventional methods. For example, conventional heating elements may require being positioned up to about 3 to 4 times further from the substrates than the IR emitter elements 56 of the present invention, thus causing about 10 to 20 times less radiant efficiency (due to the inverse square law regarding IR proximity to bodies as stated in Plank's Law and Wien's Constant). The fast heat up and cool down aspects also cause reduced energy usage and, as a result, reduced operating costs in comparison to conventional ovens.

The IR emitter module 52 in the second heating zone 46 (and/or in the first and the third heating zones 44 and 48) includes an embedded quartz thermowell (not shown) positioned in direct contact with a primary IR element 56. The thermowell includes a 1/16 inch diameter Chromel/Alumel (type “K”) thermocouple to provide precise analog process signals used as input to a controller of the system 38 or a separate closed loop element temperature digital control device. The controller also monitors temperatures within the second heating zone 46 and, more specifically, determines and monitors temperatures of the substrate surface. The controller adjusts the power (specifically, the voltage) applied to the IR emitter elements 56 in order to maintain a desired temperature profile of the substrate surface within the second heating zone 46. In addition, the controller modulates the voltage applied to the IR emitter elements 56 in the first, second, or third heating zones 44, 46 and 48 to accomplish specific IR wavelength emissions, within a range of peak wavelengths, based on required coating variations in thickness, exposure time to IR emissions, and chemical characteristics. In some implementations, the controller further controls the conveyor line 39 and thus, the speed at which the substrate passes through the curing stages 40 and 42.

While there has been shown and described what are at present considered the preferred embodiments of the invention, it will be obvious to those skilled in the art that various changes and modifications can be made therein without departing from the scope of the invention defined by the appended claims.

I claim:

1. A method of finish curing a leather-based substrate, the method comprising:
applying a base coat onto a surface of a substrate to form a coated substrate;
passing the coated substrate through a first heating zone to heat the base coat;
passing the coated substrate through a second heating zone, the second heating zone emitting infrared electromagnetic waves at a frequency corresponding to strong absorption by water to remove a desired amount of moisture from the base coat; and
passing the coated substrate through a third heating zone to completely cure the base coat on the coated substrate.

2. The method as in claim 1, in which the frequency corresponding to strong absorption by water is in a range of 2900-3100 nanometers.

3. The method as in claim 1, further comprising the step of sensing a temperature of the coated substrate passing through the second heating zone and adjusting a power level of the second heating zone to maintain a desired temperature of the coated substrate.

4. The method as in claim 1, further comprising the step of directing air over the coated substrate passing through the second heating zone to remove moisture building up on the coated substrate.

5. The method as in claim 1, further comprising the step of passing the coated substrate through a cooling unit to cool the base coat after the base coat has been completely cured.

6. The method as in claim 5, further comprising the step of applying a color coat onto the surface of the coated substrate after the coated substrate has been cooled by the cooling unit.

7. A system for finish curing a coated substrate, the system comprising:
a conveyor passing the coated substrate through a first heating zone, a second heating zone, and a third heating zone;
the first heating zone including a first infrared emitter module heating the coated substrate;
the second heating zone including a second infrared emitter module emitting infrared electromagnetic waves at a frequency corresponding to strong absorption by water to remove a desired amount of moisture from the coated substrate; and
the third heating zone including a third infrared emitter module completely curing the coated substrate.

8. The system as in claim 7, in which the frequency corresponding to strong absorption by water is in a range of 2900-3100 nanometers.

9. The system as in claim 7, further comprising a controller providing power to the second infrared emitter module to heat the second emitter module to about 1300 degrees Fahrenheit (705 degrees Celsius).

10. The system as in claim 9, in which the controller senses a temperature of the coated substrate passing through the second heating zone and adjusts a power level of the second infrared emitter module to maintain a desired temperature of the coated substrate.

11. The system as in claim 7, further comprising an air manifold directing air over the coated substrate passing through the second heating zone to remove moisture building up on the coated substrate.

12. The system as in claim 11, in which the directed air is warmed by the second infrared emitter module.

13. The system as in claim 7, in which at least one of the second infrared emitter module and the third infrared emitter module includes ceramic fiber mounted panels with perforated ventilation holes.

14. The system as in claim 7, further comprising a cooling unit, in which the conveyor passes the coated substrate through the cooling unit after the coated substrate has been passed through the third heating zone.

15. A method of finish curing a leather-based substrate, the method comprising:
applying a base coat onto a surface of a substrate to form a coated substrate;
passing the coated substrate through a first curing stage to heat, dry, and completely cure the base coat on the coated substrate, the first curing stage including at least one first heating zone emitting infrared electromagnetic waves at a frequency corresponding to strong absorption by water to remove a desired amount of moisture from the base coat;
applying a color coat onto a surface of the coated substrate to form a colored substrate; and
passing the colored substrate through a second curing stage to heat, dry, and completely cure the color coat on the colored substrate, the second curing stage including at least one second heating zone emitting infrared electromagnetic waves at the frequency corresponding to strong absorption by water to remove a desired amount of moisture from the color coat.

16. The method as in claim 17, in which the frequency corresponding to strong absorption by water is in a range of 2900-3100 nanometers.
